(19) United States
(12) Patent Application Publication
(10) Pub. No.: US 2020/0109738 A1
(43) Pub. Date: Apr. 9, 2020

(54) Climbing Hook

(71) Applicant: Steven Cimarusti, Round Lake Beach, IL (US)

(72) Inventor: Steven Cimarusti, Round Lake Beach, IL (US)

(21) Appl. No.: 16/152,097

(22) Filed: Oct. 4, 2018

(51) Int. Cl. F16B 45/02

(52) U.S. Cl. CPC F16B 45/02

(57) ABSTRACT

A climbing carabiner style hook comprising a C-shaped claw, an actuator and a gate. The actuator adapted for remote engagement to open the gate. The actuator linked to the gate to urge the gate to move from a spring retained, closed position to an open position. The actuator may be a hand lever, a finger lever or a thumb lever. The actuator is spaced from the gate and oriented generally with the grip. A linkage connects the actuator and the gate. A trigger guard may surround the actuator.

### FIELD OF THE INVENTION

The present invention relates generally to a carabiner style climbing hook.

### BACKGROUND OF THE INVENTION

The inventor has come to realize from his experience that carabiner style hooks used for climbing ladders and the like are awkward in the common configuration. Climbing hooks may comprise an open c-shaped portion of resilient material such as metal. The c-shaped portion may be claw shaped open loop. The open loop is closed by a movable gate having a first end attached to a first open end of the open loop and a second end bearing against the second end of the open loop. The gate may be hinged on the first end having a spring on the hinge to urge the gate to a closed position. The second end may have a locking or latching attachment to the second end of the open loop. The second end of the gate moves from bearing against the open loop to an open position wherein the second end of the gate is spaced from the second end of the open loop. The gate may be moved from the closed position to the open position by pressing with a finger or other device. The carabiner may be attached to a tie off point by pressing the second gate end against the tie off point to urge the gate to swing open about the hinge and allow the tie off point into the interior of the open loop. The spring may urge the gate to a closed position capturing the tie off point in the open loop thereby closed by the gate. The locking gate may be moved to an open position by interface with one or more fingers while keeping grip of the climbing hook.

Carabiners are used for a variety of connection needs including as a safety connection by climbers. The climber wears a harness having straps extending along the climbers arms. A carabiner is attached to the strap adjacent the climbers hands. The climber grips the carabiner having a spring loaded gate, in a manner having the spring loaded gate adjacent the climbers fingers. The spring loaded gate is urged to the closed position by the spring loaded hinge thereby closing the loop.

The climber prepares top climb a structure by first attaching the first carabiner to a first tie off point. A tie off point is a secure fixture such as a ring or anchor securely attached to the structure being climbed. Tie off points are generally spaced vertically from each other to facilitate climbing up and down a structure such as a tank, smoke stack or bridge. The climber then climbs to a second position to attach the second carabiner to a second tie off point. The climber disengages the first carabiner from the first tie off point by moving the gate with a finger to open the loop and disconnect the first tie off point from the first carabiner. The climber climbs to a new position spaced from the second position and attaches the first carabiner to a third tie off point. This process is repeated as the climber climbs up and down the structure.

Releasing the carabiner to release from a tie off point is time consuming and dangerous. Prior art devices required the climber release the grip on the carabiner to push the gate to the open position.

A primary object of the climbing ok is a safety hook that can be opened remotely with a finger.

Another object of the climbing hook is provide a safety to prevent accidental opening.

### SUMMARY OF THE INVENTION

The climbing carabiner invention is directed to a carabiner which can be opened re-positioning the climber's hand. The features of the invention are set out with particularity in the appended claims. The invention will be best understood from the following description when read in conjunction with the accompanying drawings. The climbing carabiner comprises a body having an open C-shaped portion, a gate and a trigger. The hook having a first hook end and a second hook end. The second hook end spaced from the first hook end. The gate pivotally attached to the first hook end. The gate having a first gate end attached to the first hook end and a second gate end. The second gate end adapted to bear against the second hook end in a closed position. The second end movable to a position spaced from the hook second end in an open position.

A hinge on the first hook end, the hinge attached to the first gate end. A spring on the hook adjacent the hinge. The spring bearing against the gate to urge the gate to the closed position. The trigger on the body. The trigger attached to the gate. The trigger adapted to move the gate from the closed position to the open position. The body may comprise a trigger guard surrounding the trigger.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a perspective view of the climbing hook on a climbing harness attached to a climber.

FIG. 2 is a side elevation view of a first embodiment of the climbing hook

FIG. 3 is a front elevation view of a second embodiment of the climbing hook.

FIG. 3a is a side elevation view of the second embodiment of the climbing hook.

FIG. 4 is a top plan view of a third embodiment of the climbing hook

FIG. 5 is a top plan view of a fourth embodiment of the climbing hook.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. (It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting.

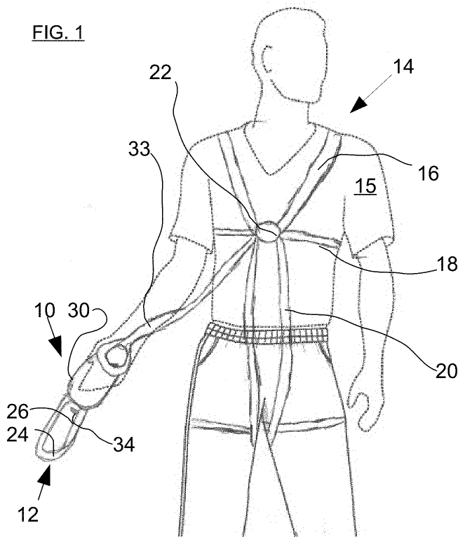

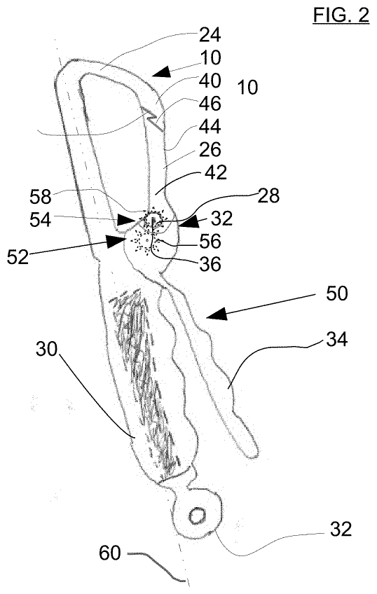

Referring to FIGS. 1 and 2, the climbing hook 10 may have a hook 12. Climbing hook 10 may be attached to a harness 14 worn by the climber 15. The harness 14 may comprise shoulder straps 16, torso straps 18 and leg straps 20. The straps 16, 18 and 20 may attach to buckle 22. The hook 12 may comprise c-shaped loop 24, gate 26 and hinge 28. Handle 30 may be attached to hook 12 and secured to harness 14 at strap loop 32. Handle axis 60 may be generally parallel with plane of hook 61

Referring to FIG. 2, climbing hook 10, may comprise trigger 34 attached to gate 26. Hinge 28 may allow gate 26 to pivot about hinge pin 36. C-shaped loop 24 may comprise first loop end 38 and second loop end 40. Gate 26 may comprise first gate end 42 and second gate end 44. First gate end 42 is pivotally attached to first loop end 38 by hinge 28. Second gate end 44 is adapted to bear against second loop end 40. Second loop end 40 may have inside notch 46 formed therein. Second gate end 44 may have outside notch 48 formed therein. Inside notch 46 is disposed to engage outside notch 48 to secure second loop end 40 to second gate end 44 closing c-shaped loop 24 with gate 26.

Continuing to refer to FIG. 2, trigger 34 comprises actuator 50, linkage 52 and connection 54. Actuator 50 may be a hand lever on the hook 12. Actuator 50 is attached to linkage 52. Linkage 52 is attached to actuator 50. Linkage is attached to connection 54. Connection 54 is on gate 26 whereby actuator 50 is mechanically linked to gate 26 whereby movement of the actuator 50 translates to movement of gate 26 about hinge pin 36. Actuator 50 is disposed adjacent handle 30. Actuator 50 moves radially with respect to handle axis 60. Actuator 50 is on linkage 52. Linkage 52 may be a gear 56 arrangement on the hook 12. Connection 54 may comprise pawl 58 on gate 26. Gear arrangement 56 bears against pawl 58 to translate movement of actuator 50 to movement of gate 26 about hinge pin 36 as is well known in hand tools.

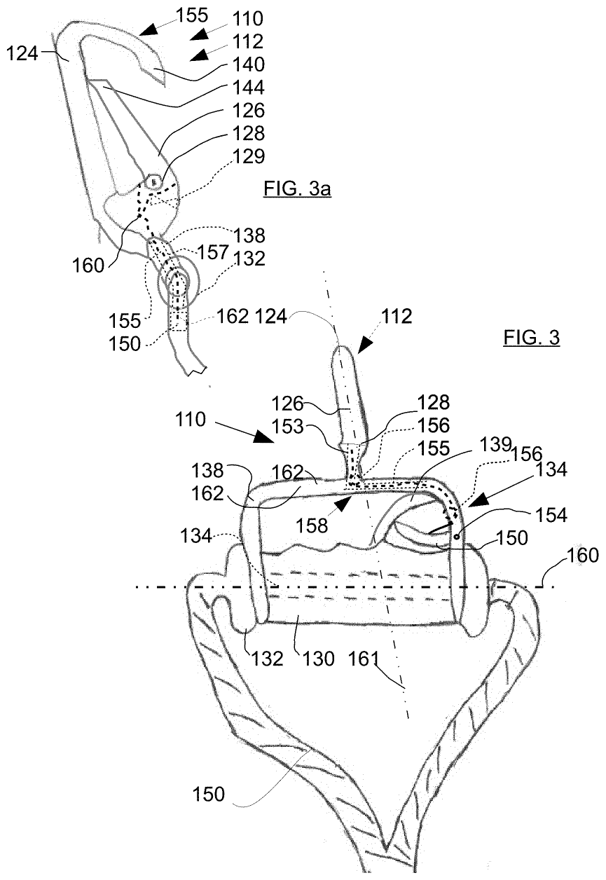

Referring to FIGS. 3 and 3a, as second embodiment of a climbing hook 110 may comprise hook 112 may comprise open loop 124, gate 126 and hinge 128. Handle 130 may be attached to hook 112 such that handle axis 161 is generally perpendicular to hook plane 161. Trigger 134 may be attached to gate 126. Hinge 128 is adapted to allow gate 126 to pivot about hinge pin 136 and generally parallel with hook plane 161. Loop 124 may comprise second loop end 140. Gate 126 may comprise first gate end 142 and second gate end 144. First gate end 142 is pivotally attached to first loop end 138 by hinge 128. Second gate end 144 is adapted to bear against second loop end 140. Second loop end 140 interlock with gate 126.

Continuing to refer to FIG. 3, trigger 134 comprises actuator 150, linkage 152 and connection 154. Actuator 150 is attached to mechanically linked to gate 126 whereby movement of the actuator 150 translates to movement of gate 126 generally along hook plane 161 Pivoting about hinge 128. Actuator 150 is adapted for engagement by the climber. Actuator 150 moves radially with respect to handle axis 161. Actuator 150 is on linkage 152. Linkage 152 may comprises a channel 153 in the hook 112 having a cable 155 therein. The cable 155 having a first end 160 and a second end 162. First cable end 156 may be attached to actuator 150. Second cable end 158 may be attached to gate 126. Actuator 150 is attached to gate 126. Alternatively, linkage 152 may be a cable or wire 155 and pulley 156 arrangement 158 in connector 154 as is well known in hand tools.

Continuing to refer to FIGS. 3 and 3a, handle axis may be generally perpendicular to hook plane 161. Hand guard 138 may connect hook to handle. Trigger guard 136 may be on hand guard surrounding trigger. Harness strap attaches to hollow handle 130. Wire 155 may traverse in conduit 157 to overcome spring 129 and urge gate 126 into an open position 155 having loop second end spaced from gate second end.

Referring to FIG. 4, a third embodiment of a climbing hook 210 may comprise hook 212 having open loop 224, gate 226 and hinge 228. Handle 230 may be attached to hook 212 such that handle 230 is spaced from hook 212. Handle 230 may have a pistol grip type configuration. Trigger 234 may be attached to gate 226. Hinge 228 is adapted to allow gate 226 to pivot about hinge pin 236. Loop 224 may comprise second loop end 240. Gate 226 may comprise first gate end 242 and second gate end 244. First gate end 242 is pivotally attached to first loop end 238 by hinge 228. Second gate end 244 is adapted to bear against second loop end 240. Second loop end 240 interlock with gate 226.

Continuing to refer to FIG. 4 trigger 234 comprises actuator 250, linkage 252 and connection 254. Actuator 250 may be thumb lever extending generally perpendicular to handle 30. Actuator 250 may be attached to linkage 252. Linkage 252 may be a ratchet pawl 254 on hook 212. Connection 254 may comprise cam lobe 260 on gate 226 whereby actuator 250 is mechanically linked to gate 226 whereby movement of actuator 250 translates to movement of gate 226 pivoting about hinge 228. Spring 229 is adapted to urge second gate end 244 to bear against second loop end 240. Spring 229 may also be disposed to urge trigger 234 to a gate closed position 259. Thumb actuator 250 is adapted for actuator by the climber. Thumb actuator 250 moves radially with respect to handle axis 260. Thumb actuator 250 is on linkage 252. Linkage 252 is bears against gate 226. Linkage 252 may be a cam arrangement 258 in connector 254 as is well known in hand tools. Handle loop 260 may be on handle 230 spaced from hook 312.

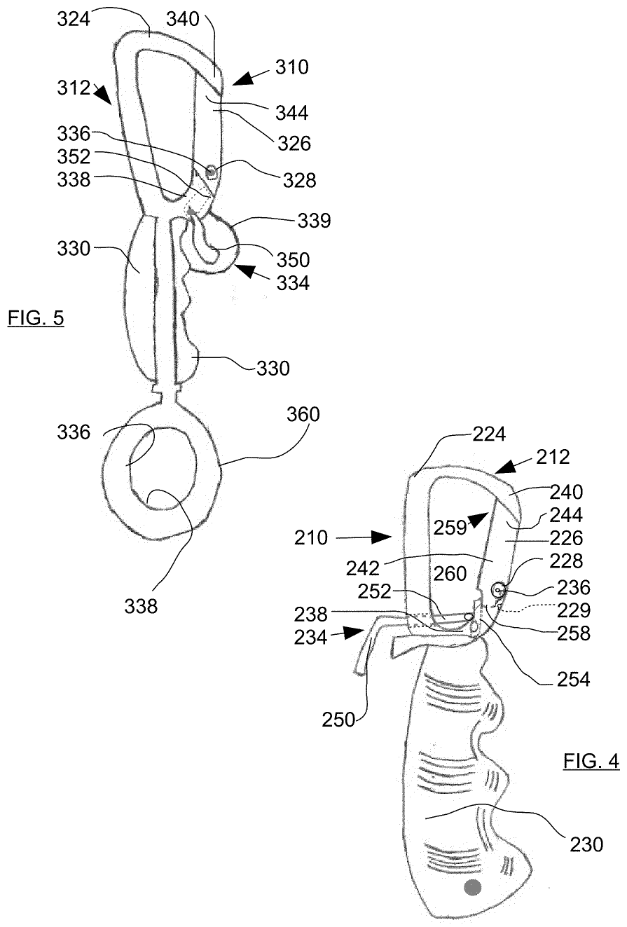

Referring to FIG. 5, a fourth embodiment of a climbing hook 310 may comprise hook 312 having open loop 324, gate 326 and hinge 328. Handle 330 may be attached to hook 312 such that handle 330 is spaced from hook 312. Trigger 334 may be attached to gate 326. Hinge 328 is adapted to allow gate 326 to pivot about hinge pin 336. Loop 324 may comprise second loop end 340. Gate 326 may comprise first gate end 342 and second gate end 344. First gate end 342 is pivotally attached to first loop end 338 by hinge 328. Second gate end 344 is adapted to bear against second loop end 340. Second loop end 340 interlock with gate 326.

Continuing to refer to FIG. 5, trigger 334 may comprise actuator 350, linkage 352 and connection 354. Actuator 350 may comprise finger lever 356 on hook 312. Linkage 352 may be gate lever 358 on actuator 350. Gate lever 358 bears against gate 326 whereby movement of actuator 350 translates to movement of gate 326 pivoting about hinge 328. Actuator 350 is adapted for Actuator by the climber. Actuator 350 moves radially with respect to handle axis 360. Actuator 350 is on linkage 352. Linkage 352 is attached to gate 326. Linkage 352 may be a cam arrangement 358 in connector 354 as is well known in hand tools. Trigger guard may be on handle 338 surrounding trigger 334. Harness strap attaches to handle loop 360.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

I claim:

1. A climbing hook comprising:
a body comprising a c-shaped portion and a gate, the c-shaped portion having a first hook end and a second hook end, the gate having a first gate end and a second gate end, the first hook end pivotally attached to the first gate end, the second gate end bearing against the second hook end,
a trigger on the body, the trigger attached to the gate, the trigger movable from a closed position wherein the second gate end bears against the second hook end, to an open position wherein the second gate end is spaced from the second hook end.

2. The climbing hook of claim 1, wherein the trigger further comprises an actuator, a linkage and a connection, the actuator attached to the body, the linkage on the actuator, the connection on the gate, the linkage attached to the connection.

3. The climbing hook of claim 2 wherein the linkage comprises a cable having a first end on the actuator and a second end on the connection.

4. The climbing hook of claim 3, wherein the linkage further comprises a channel in the body, the channel comprising an open tubular structure in the body extending between the actuator and the gate, the cable in the channel.

5. The climbing hook of claim 2, wherein the trigger further comprises a spring, the spring on the body, the spring bearing against the actuator to urge the trigger to a closed position.

6. The climbing hook of claim 4, wherein the trigger further comprises a spring, the spring on the body, the spring bearing against the actuator to urge the actuator to a closed position.

7. The climbing hook of claim 3, wherein the connection is a tie off on the gate.

8. The climbing hook of claim 2, wherein the linkage further comprises a linkage gear assembly on the actuator.

9. The climbing hook of claim 8, wherein the connection further comprises a pawl on the gate, the pawl bears against the linkage gear assembly.

10. The climbing hook of claim 9, wherein the connection further comprises a spring on the body, the spring bearing against the actuator to urge the actuator to a closed position.

11. The climbing hook of claim 2, further comprising an axis on the handle, the c-shaped portion disposed in a plane.

12. The climbing hook of claim 11, wherein the axis of the handle is generally perpendicular to the plane of the c-shaped portion.

13. The climbing hook of claim 11, wherein the axis of the handle is generally parallel to the plane of the c-shaped portion.

14. The climbing hook of claim 13, wherein the handle comprises a pistol grip.

15. The climbing hook of claim 2, wherein the actuator is selected from the group consisting of a thumb lever, a finger lever or a hand lever.

16. A climbing hook comprising:
a c-shaped portion, the c-shaped portion having a first hook end and a second hook end;
and a gate, the gate having a first gate end and a second gate end, the first hook end pivotally attached to the first gate end, the second gate end bearing against the second hook end;
an actuator on the climbing hook, the actuator attached to the gate, the actuator movable from a closed position, to an open position;
a spring on the climbing hook, the spring bearing against the actuator to urge the actuator to the closed position; and
a linkage, the linkage on the actuator, the linkage bearing against the gate.

17. The climbing hook of claim 16, further comprising a pawl on the gate, the pawl bearing against the linkage.

18. The climbing hook of claim 16, wherein the linkage is selected from the group consisting of a wire, a cam or a gear arrangement.

19. The climbing hook of claim 16, wherein the actuator is selected from the group consisting of a thumb lever, a finger lever or a hand lever.

20. A climbing hook comprising:
a handle and a c-shaped portion, the handle attached to the c-shaped portion, the c-shaped portion having a first hook end and a second hook end;
and a gate, the gate having a first gate end and a second gate end, the first hook end pivotally attached to the first gate end;
a trigger on the climbing hook, the trigger attached to the gate, the trigger adapted to move the gate to an open position;
a spring on the climbing hook, the spring bearing against the gate, the spring adapted to urge the second gate end to bear against the second hook end; and
a trigger guard, the trigger guard on the climbing hook, the trigger disposed adjacent the handle.
